(19) United States
(12) Patent Application Publication
(10) Pub. No.: US 2014/0165509 A1
(43) Pub. Date: Jun. 19, 2014

(54) FOLDING KNIFE WITH TOBACCO CAN OPENER

(71) Applicant: GB II Corporation dba Columbia River Knife & Tool Company, Tualatin, OR (US)

(72) Inventor: Russ Kommer, Fargo, ND (US)

(73) Assignee: GB II Corporation dba Columbia River Knife & Tool Company, Tualatin, OR (US)

(21) Appl. No.: 14/108,156

(22) Filed: Dec. 16, 2013

Related U.S. Application Data
(60) Provisional application No. 61/737,662, filed on Dec. 14, 2012.

(51) Int. Cl. B67B 7/44; B67B 7/46

(52) U.S. Cl. CPC B67B 7/44; B67B 7/30
USPC 53/492; 30/142; 30/143

(57) ABSTRACT

According to one representative embodiment, a knife comprises a handle having a forward end portion and a rear end portion, and a blade coupled to the forward end portion of the handle. The handle comprises first and second opposing side portions, the first side portion comprising a cutting member at the rear end portion of the handle and the second side portion comprising an extension portion at the rear end portion of the handle. The extension portion extends rearwardly past the cutting member in the direction of the length of the handle. The cutting member and the extension portion are spaced apart from each other a distance sufficient to receive the side wall of the lid of a tobacco can.

### CROSS REFERENCE TO RELATED APPLICATION

This application claims the benefit of U.S. Provisional Application No. 61/737,662, filed Dec. 14, 2012, which is incorporated herein by reference.

### FIELD

The present application concerns embodiments of a folding knife having an integral can opener for opening cans, such as cans containing chewing tobacco.

### BACKGROUND

Tobacco cans typically have a paper wrapper that completely covers the junction between the cylindrical side wall of the can and the overlapping side wall of the lid. Thus, before the lid can be removed, the wrapper must be severed along the bottom of the side wall of the lid. Conventional can or bottle openers are not effective for use in opening tobacco cans. It is known to use a sharp tool, such as the blade of a fixed blade knife or folding knife, to sever the paper wrapper and to pry the lid from the can. Unfortunately, some people may find this technique to be awkward or difficult to accomplish.

### SUMMARY

According to one representative embodiment, a knife comprises a handle having a forward end portion and a rear end portion, and a blade coupled to the forward end portion of the handle. The handle comprises first and second opposing side portions, the first side portion comprising a cutting member at the rear end portion of the handle and the second side portion comprising an extension portion at the rear end portion of the handle. The extension portion extends rearwardly past the cutting member in the direction of the length of the handle. The cutting member and the extension portion are spaced apart from each other a distance sufficient to receive the side wall of the lid of a tobacco can.

According to another representative embodiment, a knife comprises a handle comprising a forward end portion and a rear end portion, and a blade coupled to the forward end portion of the handle. The rear end portion of the handle comprises means for cutting a paper wrapper on a can of tobacco and removing a lid from the can.

According to another representative embodiment, a method is provided for removing a lid from a can having a paper wrapper covering a cylindrical side wall of the lid and an adjacent cylindrical side wall of the can. The method comprises providing a knife comprising a handle comprising a forward end portion and a rear end portion, the knife further comprising a blade coupled to the forward end portion of the handle, the rear end portion comprising a cutting member and an extension portion spaced from the cutting member. The method further comprises inserting the side wall of the lid between the cutting member and the extension portion, severing the paper wrapper with the cutting member, and removing the lid from the can.

The foregoing and other features and advantages of the invention will become more apparent from the following detailed description, which proceeds with reference to the accompanying figures.

### BRIEF DESCRIPTION OF THE DRAWINGS

FIG. 1 is a perspective view of a folding knife having an integral can opener, according to one embodiment.

FIG. 2 is a bottom plan view of the folding knife of FIG. 1.

FIG. 3 is a top plan view of the folding knife of FIG. 1.

FIG. 4 is a perspective view of the folding knife of FIG. 1, shown with the blade in the open position for use.

FIG. 5 is an enlarged view of the handle of the knife of FIG. 1, illustrating a method for removing a lid from a can using the integral can opener.

### DETAILED DESCRIPTION

For purposes of this description, certain aspects, advantages, and novel features of the embodiments of this disclosure are described herein. The described methods, systems, and apparatus should not be construed as limiting in any way. Instead, the present disclosure is directed toward all novel and nonobvious features and aspects of the various disclosed embodiments, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, systems, and apparatus can be used in conjunction with other systems, methods, and apparatus.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means physically coupled or linked and does not exclude the presence of intermediate elements between the coupled items absent specific contrary language.

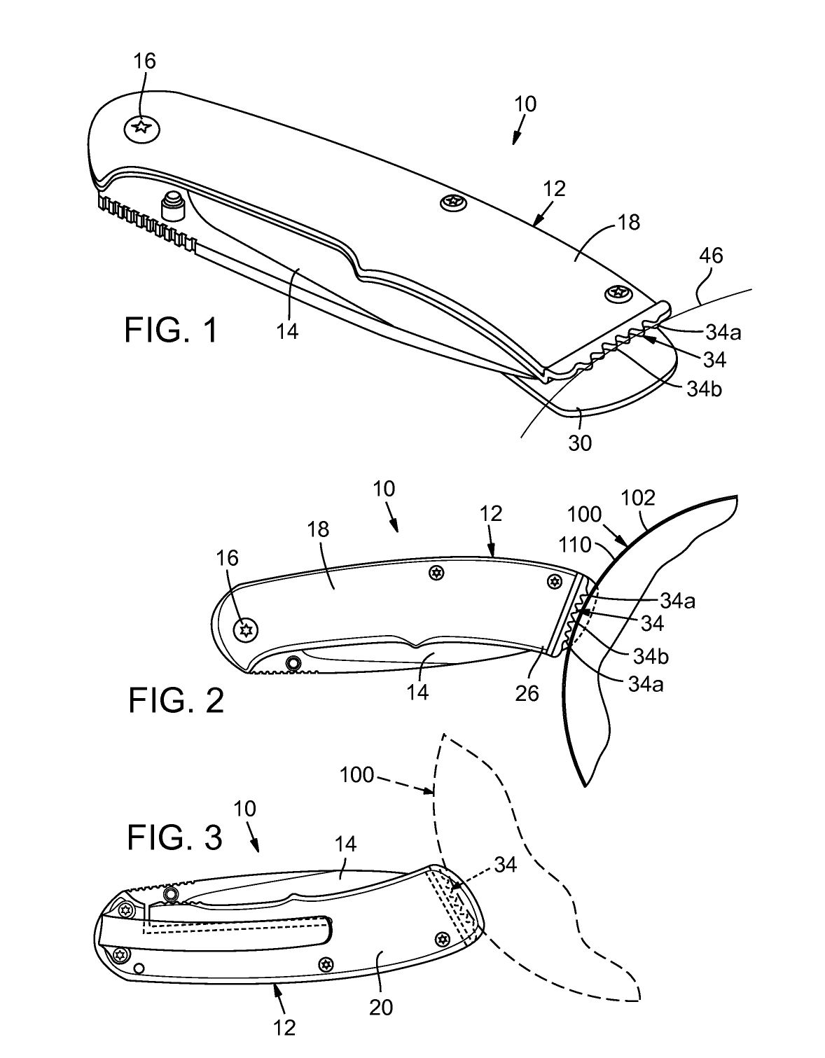

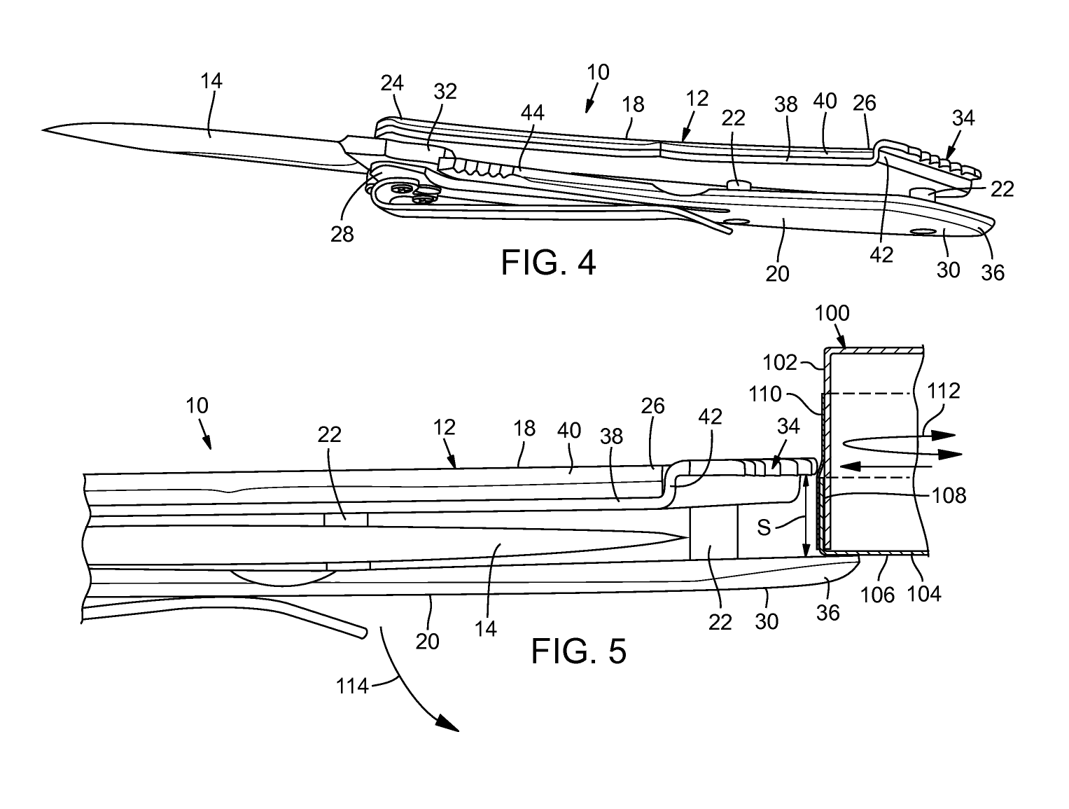

Referring to the figures, there is shown a folding knife 10, according to one embodiment. The knife 10 comprises a handle 12 and a blade 14 pivotably connected to the handle 12 by a pivot element 16 (e.g., a screw). The blade 14 is pivotable relative to the handle 12 between a closed position in which the sharpened edge of the blade is inside the handle (FIG. 1) and an open position in which the sharpened edge of the blade is exposed for use (FIG. 4).

The handle 12 in the illustrated embodiment comprises a first side portion 18 and a second, opposing side portion 20 spaced apart from the first side portion so as to define a blade-receiving cavity therebetween. The handle 12 can include one or more spacers 22 extending between and secured to the first and second side portions 18, 20, respectively, as known in the art. As best shown in FIG. 4, the first handle side portion 18 comprises a forward end portion 24 and a rear end portion 26. The second handle side portion 20 comprises a forward end portion 28 and a rear end portion 30. A tang 32 of the blade 14 is supported between the forward end portions 24 and 28. The second side portion 20 can be formed with an integral leaf spring 44 (also referred to as a “liner lock”) that can engage a rear surface of the tang 32 to hold the blade 14 in the open position, as known in the art.

The rear end portions 26 and 30 together form a can opener that is especially usefully in opening a can of chewing tobacco. The rear end portion 26 of the first side portion 18 comprises a cutting member for cutting or severing the paper wrapper that seals the lid of a can to the adjacent outer surface of the can (e.g., a can of tobacco). The cutting member in the illustrated embodiment comprises a plurality of cutting teeth or serrations 34 that are configured to tear the paper wrapper on a can. As best shown in FIG. 2, the row of teeth 34 can be slightly curved to match the curvature of the side wall of a can 100. Thus, the teeth 34a at the ends of the row are shaped to extend slightly beyond the teeth 34b between the ends of the row. A curved line 46 (FIG. 1) drawn tangent to the tips of the teeth 34 has a radius of curvature that desirably is the same as the radius of curvature of the can 100.

As best shown in FIG. 5, the rear end portion 30 of the second side portion 20 extends rearwardly past the cutting teeth 34 a short distance to define a rear extension 36 that is adapted to engage the upper surface of the lid of a can. The opposing inner surfaces of the rear extension 36 and the cutting teeth 34 define a spacing S that is large enough to receiving the side wall of the lid of a can between the rear extension 36 and the cutting teeth 34, as further discussed below.

In an alternative embodiment, the plurality of cutting teeth 34 can be replaced with a single, continuous (non-serrated) cutting edge or blade formed on the rear end portion 26 of the first side portion 18. The blade can be curved to match the curvature of the can.

The first side portion 18 can be comprised of two plate members: an inner plate member 38 and an outer plate member 40 secured to the outside surface of the inner plate member. As best shown in FIG. 5, the inner plate member 38 can include a generally S-shaped curved portion 42 that extends in a direction laterally away from the blade-receiving cavity and then in a direction parallel to the outer plate member 40. The end of the S-shape curved portion is formed with the cutting teeth 34 in the illustrated embodiment. The cutting teeth 34 desirably are integral to the inner plate member 38, that is, the teeth are machined or otherwise formed on the inner plate member 38. In alternative embodiments, the cutting teeth 34 can be formed on a separate component that is separately formed and subsequently attached to the first side portion 18. Also in alternative embodiments, the first side portion 18 can be comprised of a single plate member having cutting teeth 34 at its rear end.

FIG. 5 shows a portion a can 100, which can be a can of chewing tobacco (the can is shown in an upside-down orientation for purposes of illustration). The can 100 comprises a cylindrical side wall 102 and a lid 104. The lid 104 has an upper wall 106 and a cylindrical side wall 108 that extends downwardly from the outer circumferential edge of the upper wall 106. The side wall 108 overlaps an upper portion of the side wall 102 when the lid is in place on the can. Manufacturers typically include a tearable paper wrapper or seal 110 that extends around the side walls 108, 102 of the lid and the can.

To open the can, the upper wall 106 of the lid is placed on the inside surface of the rear extension 36 and the cutting teeth 34 are placed against the wrapper 110 just below the side wall 108 of the lid. The can 100 is then rotated relative to the knife 10 (as indicated by arrow 112), or vice versa, or the can and the knife are rotated in opposite directions to cause the teeth 34 to create a tear in the wrapper 110 extending around the can. With the teeth 34 positioned against the lower edge of the side wall 108 and while holding the can steady with one hand, the lid 104 can be pried away from the can by moving or the titling handle 18 generally in the direction of arrow 114 using the other hand.

While the illustrated embodiment of the knife 10 is described in connection with opening a can of chewing tobacco, it should be noted that the knife can be used to remove the lid of a can, regardless of the contents of the can. Further, in alternative embodiments, the can opener described above can be incorporated in the handle of a fixed based knife, rather than a folding knife as described above.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A knife comprising:
a handle comprising a forward end portion and a rear end portion; and
a blade coupled to the forward end portion of the handle;
wherein the handle comprises first and second opposing side portions, the first side portion comprising a cutting member at the rear end portion of the handle and the second side portion comprising an extension portion at the rear end portion of the handle, the extension portion extending rearwardly past the cutting member in the direction of the length of the handle, the cutting member and the extension portion being spaced apart from each other a distance sufficient to receive the side wall of the lid of a tobacco can.

2. The knife of claim 1, wherein the blade is pivotably coupled to the forward end of the handle and configured to move between an open position for use and a closed position at least partially received between the first and second side portions of the handle.

3. The knife of claim 1, wherein the cutting member comprises a plurality of cutting teeth.

4. The knife of claim 1, wherein the cutting member is curved.

5. A knife comprising:
a handle comprising a forward end portion and a rear end portion; and
a blade coupled to the forward end portion of the handle;
wherein the rear end portion of the handle comprises means for cutting a paper wrapper on a can of tobacco and removing a lid from the can.

6. A method of removing a lid from a can having a paper wrapper covering a cylindrical side wall of the lid and an adjacent cylindrical side wall of the can, the method comprising:
providing a knife comprising a handle comprising a forward end portion and a rear end portion, the knife further comprising a blade coupled to the forward end portion of the handle, the rear end portion comprising a cutting member and an extension portion spaced from the cutting member; and
inserting the side wall of the lid between the cutting member and the extension portion;
severing the paper wrapper with the cutting member; and
removing the lid from the can.

7. The method of claim 6, wherein the act of removing the lid from the can comprises prying the lid away from the can with the cutting member and the extension portion.
